(19) United States
(12) Patent Application Publication
(10) Pub. No.: US 2003/0118928 A1
(43) Pub. Date: Jun. 26, 2003

(54) Developing agent and image forming apparatus

(75) Inventor: Yoshihito Shimada, Kawasaki-shi (JP)

Correspondence Address: FOLEY AND LARDNER, SUITE 500, 3000 K STREET NW, WASHINGTON, DC, 20007, US

(73) Assignee: TOSHIBA TEC KABUSHIKI KAISHA

(21) Appl. No.: 10/011,234

(22) Filed: Dec. 7, 2001

(51) Int. Cl. G03G 9/00

(52) U.S. Cl. 430/108.1; 430/108.9

(57) ABSTRACT

Electrically semi-conductive carbon nano tube is used as a coloring agent.

### BACKGROUND OF THE INVENTION

The present invention relates to an image forming apparatus of an electrostatic recording system, an electrophotographic system, etc., and a developing agent used in the image forming apparatus.

### DESCRIPTION OF THE RELATED ART

If the coloring power of a developing agent is increased, it is possible to obtain a high image density efficiently with a small amount of toner. Also, if the toner amount is small, it is possible to obtain on the surface an image of a texture close to the original image, and free from any irregularities caused by the toner. For example, where the coloring power of a black toner is improved, it is considered effective to increase the amount of pigment added to the toner. Carbon black generally used in a black toner exhibits electrically characteristics like a metal and, thus, is electrically conductive. Therefore, if the addition amount of carbon black is increased, the resistivity of the toner is decreased, with the result that the charge obtained by the frictional charging with the carrier tends to leak. It therefore follows that the charged amount of the toner tends to be lowered. In the developing process of an electrophotographic system, toner is transferred from the developing agent layer onto the photoreceptor by an electric field, for visualizing the electrostatic latent image on the photoreceptor. However, in the developing process if the charged amount of the toner is decreased, it is difficult to control the transfer of the toner. As a result, a so-called “fogging”, i.e., the phenomenon in which toner is transferred onto the non-image portion, making it visible, takes place, or the amount of toner transferred onto the image portion is decreased, which lowers the density of the image portion. Under the circumstances, it is therefore necessary to control the addition amount of the pigment so as to achieve an appropriate charge of the toner in the electrophotographic system to which is applied the black toner in the case where carbon black is used as the pigment of the black toner. In conclusion, it was difficult in the past to simultaneously control the amount of charged toner and improve the coloring power.

It may be possible to overcome these problems by adding a magnetic powder or a dye so as to color the toner. In the two component developing system, however, a magnetic force is utilized for retaining the carrier in a developing agent layer. Therefore, if a magnetic powder is added to the toner, the attraction between the toner and the carrier is increased, which makes it difficult to transfer the toner from the developing agent layer into the image portion of the photoreceptor by utilizing the electric field alone. If a sufficiently large amount of toner is not transferred onto the image portion, the density is lowered. Also, a dye is inferior to a pigment in its resistance to light, with the result that a dye fades upon exposure to light, which renders poor the preservation capability of the formed image.

As described above, the conventional toner fails to have a sufficiently large charging amount and a high coloring power.

### BRIEF SUMMARY OF THE INVENTION

An object of the present invention is to obtain a developing agent having a sufficiently large charging amount a high coloring power.

According to a first aspect of the present invention, there is provided a developing agent comprising toner particles containing a binder resin and a carbon nano tube having an electrical semi-conductivity.

According to a second aspect of the present invention, there is provided an image forming apparatus, comprising:

an image carrier;

a developing device arranged to face the image carrier, housing a developing agent comprising toner particles containing a binder resin and a carbon nano tube having electrically semi-conductivity, to develop the electrostatic latent image formed on the image carrier to form a developing agent image;

a transfer device for transferring the developing agent image onto a transfer material; and

a fixing device to fix the developing agent image transferred onto the transfer material.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a model drawing partially showing as an example the shape of a carbon nano tube; and

FIG. 2 schematically shows as an example the construction of an image forming apparatus of the present invention.

### DETAILED DESCRIPTION OF THE INVENTION

According to the first aspect of the present invention, there is provided a developing agent comprising toner particles containing a binder resin and a coloring agent, in which electrically semi-conductive carbon nano tube is used as a coloring agent.

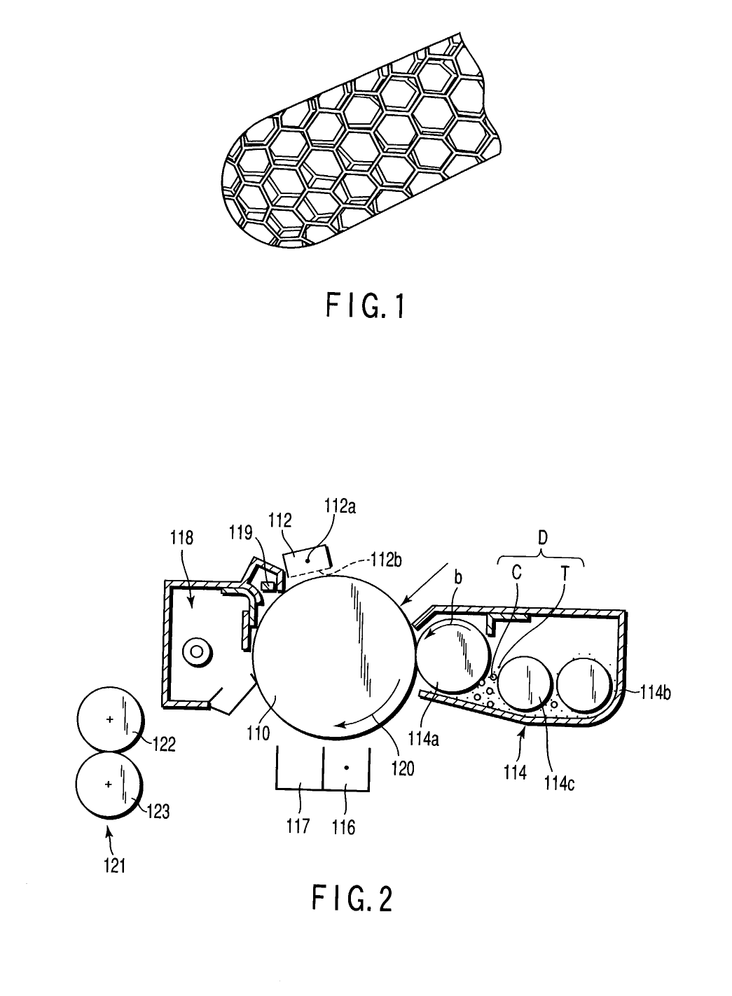

The carbon nano tube used in the present invention is black, like carbon black and, thus, can be used as a pigment. The carbon nano tube is constructed such that carbon atoms are arranged to form a cylindrical configuration. FIG. 1 partially shows as an example the shape of a carbon nano tube.

As shown in FIG. 1, a carbon nano tube has the shape of a mesh-like graphite sheet structures consisting of 6-membered rings of carbon atoms, being formed into a cylinder, and the edge portions of the cylinder are closed to form, for example, the shape of 5-membered rings of carbon atoms. Owing to this particular construction, it is possible for carbon nano tube to exhibit various conductive properties, ranging between a semi-conductive conductivity and a metallic conductivity.

In the present invention, carbon nano tube exhibiting a semi-conductive conductivity is selected and used.

Carbon nano tube can be synthesized by, for example, an arc discharge method in which an arc is generated within an inert gas by a carbon electrode, a plasma CVD method, a thermal CVD method, a surface decomposition method, and a fluidized gaseous layer synthesizing method. The arc discharge method will now be described in detail.

Specifically, a pair of carbon rods are arranged as positive and negative electrodes respectively within a chamber filled with an inert gas, such as He or Ar, and a DC voltage is applied from the outside to the carbon electrodes. A DC arc discharge is brought about under the state that a current of 60 to 80A flows between the two carbon electrodes. As a result of the arc discharge, the carbon electrode on the anode side is reduced so as to generate a deposit on the tip of the carbon electrode on the cathode side. Carbon nano tubes are present in the deposit. However, conductive carbon nano tubes and semi-conductive carbon nano tubes are present together in the deposit. It is possible to selectively remove the carbon nano tubes exhibiting semi-conductive electrical characteristics by a technology called constructive destruction. In this technology, a voltage is applied to the carbon nano tubes. In this case, current flows selectively through the conductive carbon nano tubes, thereby selectively destroying the conductive carbon nano tubes.

It follows that it is possible to manufacture carbon nano tubes exhibiting semi-conductive electrical characteristics by employing this technology.

Carbon nano tube has a diameter in the nanometer order, and it is possible to control the length of carbon nano tube in the micron order. It follows that the carbon nano tube is small enough to be added sufficiently to the toner.

In the developing agent of the present invention, the electrically semi-conductive carbon nano tube is used as a black coloring agent and, thus, even if the addition amount of the black coloring agent is increased over the ordinary level, the charge amount of the developing agent is not lowered. It follows that the use of the developing agent of the present invention permits controlling the charge amount of the toner and also permits improving the coloring power simultaneously. Also, carbon nano tube exhibits a sufficient resistance to light, substantially equal to that of carbon black.

A preferred developing agent of the present invention comprises a toner containing a binder resin and a coloring agent, and a carrier, in which electrically semi-conductive carbon nano tube is used as the coloring agent.

According to the preferred developing agent of the present invention, the charge amount of the developing agent is not lowered even if the addition amount of the black coloring agent is increased, compared with the ordinary level. It follows that the preferred developing agent of the present invention permits controlling the charge amount of the toner and also permits improving the coloring power simultaneously. Also, since carbon nano tube that does not exhibit magnetic properties is used as the coloring agent, the coloring power can be improved without obstructing the two component developing phenomenon, even if the addition amount of the coloring agent is increased.

In the developing agent of the present invention, it is desirable for the carbon nano tube content to fall within a range of between 1% by weight and 30% by weight, more desirably between 7% by weight and 20% by weight, based on the total weight of the toner particles. If the carbon nano tube content is lower than 1% by weight, the developing agent fails to exhibit a sufficiently high coloring power, resulting in failure to obtain a required image density. On the other hand, if the carbon nano tube content exceeds 30% by weight, the photoreceptor drum is much abraded because carbon nano tubes have a very high mechanical strength, resulting in failure to obtain a clear image.

It is desirable for the carbon nano tubes to have a length not larger than 5 μm, more desirably to have a length not larger them 2 μm. If the length of the carbon nano tubes exceed 2 μm, this can be longer than the toner particle diameter in such a case the surface of the photoreceptor drum tends to be abraded, which can make it difficult to obtain a clear image.

Copolymers of styrene or substituted styrene and acrylic resins used as a binder resin for the conventional toner can also be used as the binder resin in the present invention.

The copolymers of styrene or substituted styrene, which are used in the present invention, include, for example, styrene homopolymer, hydrogenated styrene resin, styrene-isobutylene copolymer, styrene-butadiene copolymer, acrylonitrile-butadiene-styrene terpolymer, acrylonitrile-styrene-acrylic acid ester terpolymer, styrene-acrylonitrile copolymer, acrylonitrile-acrylic rubber-styrene terpolymer, acrylonitrile-chlorinated polystyrene-styrene terpolymer, acrylonitrile-EVA-styrene terpolymer, styrene-p-chlorostyrene copolymer, styrene-propylene copolymer, styrene-butadiene rubber, styrene-maleic acid ester copolymer, styrene-isobutylene copolymer and styrene-maleic anhydride copolymer.

On the other hand, the acrylic resins used in the present invention include, for example, polyacrylate, polymethacrylate, polyethyl methacrylate, poly-n-butyl methacrylate, polyglycidyl methacrylate, poly-fluorine-containing acrylate, styrene-methacrylate copolymer, styrene-butyl methacrylate copolymer, and styrene-ethyl acrylate copolymer.

In addition, it is also possible to use, for example, polyvinyl chloride, polyvinyl acetate, polyethylene, polypropylene, polyester, polyurethane, polyamide, epoxy resin, phenolic resin, urea resin, polyvinyl butyral, polyacrylic acid resin, rosin, denatured rosin, terpene resin, aliphatic or alicyclic hydrocarbon resin, aromatic petroleum resin, chlorinated paraffin, and paraffin wax. These materials can be used singly or in the form of a mixture of at least two of these materials.

Also, it is possible to add at least one kind of charge controlling agent to the toner particles of the developing agent of the present invention. The charge controlling agent used in the present invention is selected from the group of negative controlling agents consisting of, for example, a metal chelate of alkyl salicylic acid, chlorinated polyester, polyester having excessive acidic groups, chlorinated polyolefin, a metal salt of a fatty acid, and a fatty acid soap.

The image forming apparatus according to the second aspect of the present invention is an image forming apparatus using the developing agent described above. Specifically, the image forming apparatus of the present invention comprises an image carrier, a developing device arranged to face the image carrier and serving to develop the electrostatic latent image formed on the image carrier with the developing agent specified in the present invention so as to form a developing agent image, a transfer device for transferring the developing agent image onto a transfer material, and a fixing device to fix the developing agent image transferred onto the transfer material. The developing agent housed in the developing device includes toner particles containing a binder resin, and 1 to 30% by weight of electrically semi-conductive carbon nano tube.

The construction of an image forming apparatus according to one embodiment of the present invention will now be described with reference the accompanying drawing. Specifically, FIG. 2 shows as an example the image forming apparatus to which is applied the developing agent of the present invention.

As shown in the drawing, a developing device 114 is arranged to face an image carrier (photoreceptor drum) 110 that is arranged rotatable. The photoreceptor drum 110 is rotated by a main motor (not shown) in the direction denoted by an arrow 120. An electrostatic latent image corresponding to the image information to be recorded is formed on the surface of the photoreceptor drum 110 by a laser beam emitted from a laser light exposure device arranged separately.

Arranged around rotating direction of the photoreceptor drum 110 are a charging device 112 for charging the photoreceptor drum 110 at a predetermined potential, a developing device 114 for developing the electrostatic latent image formed on the surface of the photoreceptor drum 110 by supplying a toner to the electrostatic latent image, a transfer device 116 for transferring the toner image formed on the surface of the photoreceptor drum 110 onto a paper sheet, a cleaning device 118 for scraping off the toner remaining on the surface of the photoreceptor drum 110, i.e., the toner that has not been transferred onto the paper sheet, and a destaticizing device for eliminating the charge remaining on the surface of the photoreceptor drum 110.

FIG. 2 shows that the destaticizing device 119 is formed integral with the housing of the cleaning device 118. However, it is also possible to arrange separately the destaticizing device 119. It is also possible to arrange a toner destaticizing device 117 for facilitating the cleaning of the untransferred toner between the cleaning device 118 and the transfer device 116. Further, it is possible to arrange separately a destaticizing device (not shown) between the developing device 114 and the transfer device 116 in order to facilitate the toner image transfer onto the paper sheet.

The cleaning device 118 includes a drum holding section for holding the photoreceptor drum 110 when the photoreceptor drum 110 is mounted to the image forming apparatus 1 and, thus, can be utilized as a drum holder.

The charging device 112 includes a corona wire 112a and a grid screen 112b and is connected to a high voltage generating circuit (not shown) and a grid bias voltage generating circuit (not shown) so as to charge the surface of the photoreceptor 110 at a predetermined surface potential.

Housed in the developing device 114 is toner T including toner particles containing a binder resin and 1 to 30% by weight of electrically semi-conductive carbon nano tubes. A magnetic brush is formed on a developing roller 114a for supporting a developing agent D prepared by mixing the toner T and magnetic carriers C covered with an insulating resin at a predetermined mixing ratio. The magnetic brush thus formed is brought into contact with the photoreceptor drum 110 arranged to face the developing roller 114a so as to develop the electrostatic latent image formed on the surface of the photoreceptor drum 110. Incidentally, the developing agent D and the developing roller 114a are housed in a housing 114b. Guide rollers 114c for maintaining constant the distance between the surface of a nonmagnetic sleeve forming the outer circumferential surface of the developing roller 114a and the photosensitive layer on the surface of the photoreceptor drum 110 are arranged in both edge portions in the longitudinal direction of the developing roller 114a. In addition to the use of the guide rollers 114c noted above, it is also possible to arrange a material having a predetermined thickness in the edge portion of the photoreceptor drum 110 by means of bonding or coating so as to maintain constant the distance noted above. It follows that the distance between the surface of the developing sleeve and the photosensitive layer of the photoreceptor drum 110 can be kept constant.

Incidentally, a magnet medium, in which a plurality of fixed magnets of the S pole and that of the N pole are arranged at a predetermined angular distance in the circumferential direction, is housed in the developing sleeve of the developing roller 114a.

In developing the electrostatic latent image formed on the surface of the photoreceptor drum 110, the toner attached by the enantiomorphous force to the ears of the carriers formed on the sleeve along the magnetic lines of force generated from the main pole of the magnet medium of the developing roller 114a is transferred in the developing region, in which the developing roller 114a is positioned to face the photoreceptor drum 110, by the electric field formed by the potential of the electrostatic latent image on the surface of the photoreceptor drum 110 and the developing bias voltage, with the result that the electrostatic latent image is developed so as to obtain a developing agent image on the surface of the photoreceptor drum 110.

The developing agent image thus formed on the surface of the photoreceptor drum 110 is transferred by the transfer device 116 onto a transfer material such as a paper sheet. Then, the transfer material bearing the developing agent image is transferred to the fixing device 121 including a heat roller 122 and a pressurizing roller 123. As a result, the developing agent image is fixed to the transfer material so as to form an image on the transfer material.

### EXAMPLES

### Example 1

Prepared were toner materials of the composition shown in Table 1 below:

TABLE 1
(Toner Materials)

| | | Addition | Addition |
|---|---|---|---|
| | | amount | method |
| Binder | polyester resin | 84 wt % | Internal |
| resin | | | addition |
| Pigment | carbon nano tube | 5 wt % | |
| CCA | Zr complex CCA | 1 wt % | |
| Wax | rice wax | 10 wt % | |
| External | hydrophobic | 1 wt % | External |
| additive | silica | | addition |

The binder resin, the carbon nano tube, CCA, and the wax shown in Table 1 were preliminarily mixed, followed by subjecting the resultant mixture to a melt kneading so as to obtain a kneaded mass.

The resultant kneaded mass was dried, followed by a rough pulverization, a fine pulverization and classification so as to obtain toner particles having an average particle diameter of 8 μm. Further, hydrophobic silica was mixed with the resultant toner particles so as to obtain a toner.

The resultant toner was evaluated as follows:

Coloring Power Test:

A developing agent was prepared by mixing the toner obtained as above with carriers. Solid images differing from each other in the image concentration were formed by using the developing agent thus prepared, with the toner ratio set at various concentrations. Used for forming the solid images was a nonmagnetic two component copying machine FANTAGIA 22. The toner weight per unit volume on the image in respect of the image having an image concentration of 1.7 as measured by a Macbeth densitometer among the images obtained so as to determine the coloring power. In this case, the coloring power is judged to be high with a decrease in the toner weight per unit volume. The results are shown in Table 2.

Measurement of Resistance:

The obtained toner was pelletized into a flat plate. Electrodes were brought into contact with the front and back surfaces of the pellet and an AC electric field was applied across the electrodes so as to measure the resistance. The results are shown in Table 2.

Charge Amount:

The obtained toner and carriers having a weight ratio of 7:93 were mixed for 30 minutes within a Turbler mixer, and the charge amount per unit weight was measured by a suction type blow off. The results are shown in Table 2.

Light Resistance Test:

A developing agent was prepared by mixing the obtained toner with carriers. After an image was formed by using the developing agent, the image density was measured with a Macbeth densitometer. The image was exposed to light by leaving the image to stand in daylight, regardless of the weather conditions. The image density after the light exposure was similarly measured so as to further examine the change in the image density. The results are shown in Table 2. The mark “x” shown in Table 2 denotes that the image density after the exposure to light was decreased by at least 0.5, as measured by a Macbeth densitometer. The mark “◯” denotes the evaluation results of the other cases.

### Examples 2 and 3

A toner was obtained as in Example 1, except that the addition amount of the carbon nano tube was changed to 7.0% and 20% by weight for Examples 2 and 3, respectively. Similar tests and evaluations were performed on the obtained toner. The results are shown in Table 2.

### Comparative Examples 1 to 4

Toners for Comparative Examples 1 to 4 were obtained as in Example 1, except that 5.0% by weight of a carbon black, 7.0% by weight of a carbon black, 5.0% by weight of a magnetic powder and 5.0% by weight of an aniline black were added in Comparative Examples 1, 2, 3 and 4, respectively, as a coloring agent in place of the carbon nano tube added in Example 1. Similar tests and evaluations were performed on the obtained toner. The results are shown in Table 2.

TABLE 2

| | | Addition | | | | | |
|---|---|---|---|---|---|---|---|
| | | amount | | | | Two | |
| | | of | Coloring | | Charge | component | Resistance |
| | Pigment | pigment | power | Resistivity | amount | development | to light |
| Comparative | Carbon | 5.0 wt % | 0.8 mg/cm² | 15E10 Ωcm | 20 uq/g | ◯ | ◯ |
| Example 1 | black | | | | | | |
| Comparative | Carbon | 7.0 wt % | 0.5 mg/cm² | 12E8 Ωcm | 5 uq/g | ◯ | ◯ |
| Example 2 | black | | | | | | |
| Comparative | Magnetic | 5.0 wt % | 0.8 mg/cm² | 12E10 Ωcm | 10 uq/g | X | ◯ |
| Example 3 | powder | | | | | | |
| Comparative | Aniline | 5.0 wt % | 0.9 mg/cm² | 25E10 Ωcm | 30 uq/g | ◯ | X |
| Example 4 | black | | | | | | |
| Example 1 | Carbon | 5.0 wt % | 0.8 mg/cm² | 17E10 Ωcm | 20 uq/g | ◯ | ◯ |
| | nano tube | | | | | | |
| Example 2 | Carbon | 7.0 wt % | 0.5 mg/cm² | 20E10 Ωcm | 21 uq/g | ◯ | ◯ |
| | nano tube | | | | | | |
| Example 3 | Carbon | 20.0 wt % | 0.2 mg/cm² | 22E10 Ωcm | 22 uq/g | ◯ | ◯ |
| | nano tube | | | | | | |

As is apparent from a comparison between Comparative Examples 1 and 2, the coloring power is increased, if the addition amount of the carbon black is increased. In this case, however, the resistivity is rapidly lowered, which lowers the charge amount. As a result, fogging was generated, which rendered the image defective.

Also, as is apparent from a comparison between Comparative Examples 1 and 3, if a magnetic power is used as a coloring agent, it is certainly possible to obtain a coloring power equal to that in the case of using carbon black. However, the toner concentration within the developing agent layer is not stable, resulting in a failure to form an image after only printing on several paper sheets. It follows that the toner for Comparative Example 3 was not adapted for two component development.

Also, as apparent from a comparison between Comparative Examples 1 and 4, if a dye is used as a coloring agent, the charge amount is markedly increased and the resistance to light is rendered poor, though the coloring power is not appreciably changed.

Also, as is apparent from a comparison between Comparative Example 1 and Example 1, if carbon nano tube is used as a coloring agent, substantially the same coloring power is exhibited and substantially the same results are obtained in respect of the resistivity and the charge amount in the case of adding the carbon nano tubes in an amount equal to that of carbon black. Further, it has been confirmed that the use of carbon nano tube is adapted for two component development and is substantially equal to the use of carbon black in respect of resistance to light.

Further, as is apparent from a comparison among Examples 1, 2 and 3, the coloring power is increased with an increase in the addition amount of carbon nano tube, as in the case of adding carbon black. Also, the resistivity and the charge amount are stable in the case of adding carbon nano tube.

As is apparent from the experimental data, the black toner containing at least 5% by weight, preferably 7 to 20% by weight, of electrically semi-conductive carbon nano tubes, and a developing agent using the particular toner permit increasing the coloring power without giving rise to any problems.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A developing agent comprising toner particles containing a binder resin and carbon nano tube having an electrical semi-conductivity.

2. The developing agent according to claim 1, wherein the content of said carbon nano tube falls within a range of between 1% by weight and 30% by weight based on the total resin amount of the toner particles.

3. The developing agent according to claim 1, wherein the content of said carbon nano tube falls within a range of between 7% by weight and 30% by weight based on the total resin amount of the toner particles.

4. The developing agent according to claim 1, wherein said carbon nano tube has a length not larger than 2 μm.

5. The developing agent according to claim 1, wherein said electrically semi-conductive carbon nano tube is obtained by a constructive destruction method.

6. The developing agent according to claim 1, wherein said binder resin contains at least one kind of resin selected from the group consisting of styrene, a copolymer of a substituted styrene, and an acrylic resin.

7. The developing agent according to claim 1, further comprising a carrier.

8. The developing agent according to claim 1, wherein said toner particles contain at least one charge controlling agent selected from the group consisting of metal chelate of alkyl salicylic acid, chlorinated polyester, polyester having excessive acid radicals, chlorinated polyolefin, a metal salt of an aliphatic acid, and an aliphatic acid soap.

9. An image forming apparatus, comprising:
an image carrier;
a developing device arranged to face the image carrier, housing a developing agent comprising toner particles containing a binder resin and electrically semi-conductive carbon nano tubes, to develop an electrostatic latent image formed on the image carrier to form a developing agent image;
a transfer device to transfer said developing agent image onto a transfer material; and
a fixing device to fix said developing agent image transferred onto a transfer material.

10. The image forming apparatus according to claim 9, wherein the content of said carbon nano tube falls within a range of between 1% by weight and 30% by weight based on the total resin amount of the toner particles.

11. The image forming apparatus according to claim 9, wherein the content of said carbon nano tube falls within a range of between 7% by weight and 30% by weight based on the total resin amount of the toner particles.

12. The image forming apparatus according to claim 9, wherein said carbon nano tube has a length not larger than 2 μm.

13. The image forming apparatus according to claim 9, wherein said electrically semi-conductive carbon nano tube is obtained by a constructive destruction method.

14. The image forming apparatus according to claim 9, wherein said binder resin contains at least one kind of resin selected from the group consisting of styrene, a copolymer of a substituted styrene, and an acrylic resin.

15. The image forming apparatus according to claim 9, further comprising a carrier.

16. The image forming apparatus according to claim 9, wherein said toner particles contain at least one charge controlling agent selected from the group consisting of a metal chelate of alkyl salicylic acid, chlorinated polyester, polyester having excessive acid radicals, chlorinated polyolefin, a metal salt of an aliphatic acid, and an aliphatic acid soap.
